(19) United States
(12) Patent Application Publication
(10) Pub. No.: US 2012/0216456 A1
(43) Pub. Date: Aug. 30, 2012

(54) GREEN WALL AND RELATED METHOD FOR ENCOURAGING THE ANCHORING OF PLANTS

(75) Inventors: Pierre Boulanger, Jumet (BE); Vincent Lieffrig, Jumet (BE)

(73) Assignee: AGC Glass Europe, Bruxelles (Watermael-Boitsfort) (BE)

(21) Appl. No.: 13/505,898

(22) PCT Filed: Nov. 17, 2010
(86) PCT No.: PCT/EP2010/067634

§ 371 Date: May 3, 2012

(30) Foreign Application Priority Data
Nov. 18, 2009 (BE) BE 2009/0717

(51) Int. Cl. A01G 17/04; A01G 1/00

(52) U.S. Cl. 47/47; 47/58.1 R

(57) ABSTRACT

The invention relates to a green wall including a plurality of plant subjects rooted in the ground immediately next to the wall and attached to the surface of a glass substrate. The invention also relates to a method for encouraging climbing plants to anchor to a wall including the attachment of the plants to a glass substrate.

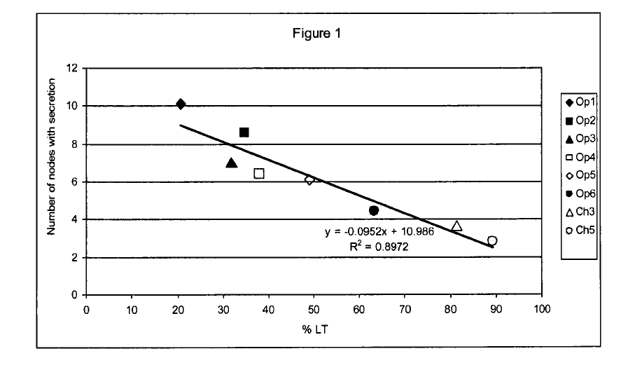

### 1. FIELD OF THE INVENTION

The present invention relates to walls covered with climbing plant subjects.

### 2. PRIOR ART SOLUTIONS

Green walls used for landscaping civil engineering structures and buildings are known (FR 2 747 265 A1). These green walls provide solutions to the problems of heat insulation and sound insulation encountered in built-up areas. The known green walls allow plants to root on rot-proof cloths placed high up on a green wall and provided with an automatic watering system. The presence of photosynthetic organisms contributes to capturing atmospheric CO₂.

Light, perforated structures in the form of trellis, lathing or even simply stakes on which it is relatively easy to cause certain plants, rooted at the base of the structures, to climb so as to form more or less dense green walls have also been known for a long time.

However, these known structures are not without drawbacks, such as the high cost of the complex structure and the watering of the green walls according to FR 2 747 265 A1 and of the fragility of walls of perforated structures, unsuitable for covering whole walls of buildings or providing effective insulation.

### 3. OBJECTIVES OF THE INVENTION

The invention consequently addresses green walls free of the drawbacks of the known systems and capable of covering all of the surfaces of a building or of a civil engineering structure while providing good insulation. The invention also aims to provide such green walls which are robust and resistant to bad weather while keeping a limited cost while at the same time providing a substantial insulation result.

### 4. SUMMARY OF THE INVENTION

To this effect, the invention relates to a green wall comprising a solid support which has a surface covered with a plurality of living climbing plant subjects rooted in the soil immediately next to the wall and attached to the surface of the support, according to which the support is selected from glass objects.

The plant subjects suitable for the green wall according to the invention belong to the category of climbing plants, i.e. to any type of plant capable of rising by leaning, attaching or winding on, to or around a support. More particularly in this case, the climbing plants suitable for the wall according to the invention are plants capable of rising by attaching to the surface of the solid glass support. In this category are the living organisms of the cormophyte plant kingdom (higher plants with stems), and mainly the flowering plants (angiospermae) of various orders in the phylogenetic classification, such as the orders rosales (rosales), apiales (araliales), vitales (vitales), and in particular the family Moraceae, Ficus genus for the order rosales, the family Araliaceae, ivy genus (hederae) for apiales, and the family Vitaceae, genus parthenocissus, ampelopsis and cissus, commonly called “virgin vines”, for vitales. Among Ficus and ivies, the climbing categories such as Ficus pumila (climbing fig) and Hedera helix (English ivy or common ivy) have given good results.

According to the invention, the plant subjects are rooted in the soil immediately next to the wall, i.e. at a distance sufficiently close to said wall for the plant subject to be able to come into contact with it as soon as it grows to more than a few centimeters above the soil. This distance does not generally exceed 30 cm, and preferably not 20 cm.

Preferably, the glass of the object forming a support is chosen from textured glasses and glasses coated with at least one coat comprising at least one metal or one metal oxide. The term “textured glass” is intended to mean sandblasted glasses, cast glasses and printed glasses, the surface finish of which has irregularities forming a repeating or random pattern. As for the glasses coated with at least one coat, they are coated with a single thin coat or, as a variant, with a stack of thin coats transparent to visible light, consisting of one or more metals or metal oxides. Textured glasses coated with at least one coat comprising at least one metal or one metal oxide are also part of the glasses in accordance with the green wall according to the invention. All the glasses mentioned above may also comprise, on at least one part of their opposite face, an opaque or translucent coating such as enamels, paint, etc.

The glass object used as support for the green wall in accordance with the invention can have external surfaces of any shape. Generally, however, sheets of flat glass are used as support, because they are appropriate for forming a wall. These sheets are most commonly planar and sometimes slightly curved in one or even two directions. The glass sheets are generally placed vertically or at an angle which does not exceed 50 degrees of angle relative to the vertical direction. For façades or roofs, this angle can exceed 50 degrees and can range up to 100 degrees, preferably less than and most preferably less than 80 for better capturing of direct solar rays.

Surprisingly, it has been noted that the phenomenon of attachment of plant subjects is better when the luminous transmittance level of the glass is low. Preferably, this level does not exceed 65%, measured through a sheet thickness of 4 mm with a daylight-type source standardized as D65 by the CIE (Commission Internationale de l'Eclairage) [International Commission on Illumination] at a solid angle of observation of 2°. Particularly preferably, use is made of a glass for which this luminous transmittance level, measured under the same conditions as those given above, does not exceed 55%. Most preferably, a glass of which the luminous transmittance level does not exceed 40% is chosen.

The metallic coat which can cover the glass support according to one variant of the invention may be a coat of metal or of metal alloy, in particular non-oxidizing metal alloys such as iron-, nickel- and chromium-based alloys.

When the glass used for the green wall in accordance with the invention is a glass coated with at least one coat of metal oxide, the metal oxide is preferably an element belonging to one of columns 4, 6, 8, 9 and 14 of the periodic table of elements. In particular, the metal oxide is preferably chosen from the Fe, Ru, Os, Co, Rh, Ir, Cr, Mo, W, Ti, Zr, Hf, C, Si, Ge, Sn and Pb oxides.

According to one variant of the green wall in accordance with the invention, the coat of metal oxide is a hard pyrolytic coat. Such a coat can be obtained by means of a technique of spraying or of chemical vapor deposition (CVD) of one or more metal oxides on a ribbon of hot glass during manufacture, or else on the surface of the molten glass in the tank for floating this glass on a bath of molten tin (“float” process).

According to one embodiment of the green wall in accordance with the invention, the coating of the glass sheet may consist only of a single coat of metal oxide. Such a single coat comprises, for example, the Fe, Co and Cr oxides. As a variant, the single coat may comprise a Ti oxide.

According to another embodiment of the green wall, the coating of the glass sheet may also consist of at least two coats of metal oxides. In this case, a coating having given good results consists of two superimposed coats, the first being an undercoat of Si oxide or of a Si oxycarbide and the second a coat of Sn oxide. Preferably, in the second coat, the Sn oxide is doped by means of F or Sb atoms.

The invention also relates to a method for encouraging nodes of climbing plants to anchor to a substantially vertical wall, according to which the plants are aligned so as to bury their roots in a soil immediately next to the base of a wall which has a surface of textured glass or of glass coated with at least one coat in accordance with that of the green wall according to the invention, and the roots and/or the leaves of the plants are provided with water and nutritive elements, and also lighting is provided by means of a visible light sufficient to allow the growth of said plants via photosynthesis.

In this method, the terms have the same definitions as those of the identical terms defined above for the green wall in accordance with the invention.

The invention will now be described by means of the examples which follow and which have no other purpose than to illustrate this invention more clearly, without seeking to limit the scope thereof.

### 5. FIGURE

Other features and advantages of the invention will emerge more clearly on reading the following description of a preferential embodiment, given by way of simple illustrated and nonlimiting example, and an appended FIGURE, showing a curve illustrating the correlation between the number of nodes with secretion and the luminous transmittance.

### 6. DESCRIPTION OF AT LEAST ONE EMBODIMENT OF THE INVENTION

Tests for attachment of a climbing plant to various panels of flat and planar glass of 21 cm×29.5 cm (A4 format) were carried out.

To do this, Ficus pumila (L.) plants originating from a commercial nursery gardener were placed in an air-conditioned room under the following conditions:
daytime temperature: 20° C.;
nighttime temperature: 18° C.;
relative hygrometry: 700;
lighting via fluorescent tubes under an intensity of 110 μmol·m⁻²·s⁻¹;
lighting time: 16 h/day;
substrate: horticultural compost;
individual plant container: pot 10 cm in diameter.

Each plant was watered regularly for 10 days of day/night lighting cycle. Then, A4 sized glass panels rinsed with distilled water were placed on metal frames, one panel opposite each plant, previously sized so as to allow 3 stems to stay alive per pot and per panel. The stems were attached to the glass panel by means of matt transparent adhesive paper at the level of the point of attachment of the two leaves located at the upper end of the stem under the shoot.

The plants were left to grow, subjected to the day/night lighting cycle and to regular watering of the compost substrate, for a period of 35 days.

The attachment of the Ficus pumila (L.) plants was examined at the end of the growth test by measuring or evaluating a certain number of properties:
plant tropism (qualitative evaluation);
counting of nodes with secretions;
counting of nodes with secretion per stem;
counting of nodes anchored per stem;
secretion surface area;
adhesion strength.

The various types of glass panels used were the following:
non-colored, printed, textured glass;
textured glass;
glass coated with a hard coat comprising oxides of Fe, of Co and of Cr;
glass coated with a hard coat comprising titanium oxide;
glass coated with a hard coat comprising fluorine-doped tin oxide;
glass with a surface chemically modified by incorporation of aluminum oxide, copper oxide, zinc oxide, tin oxide, silver oxide;
textured glass coated with a metallic coat of non-oxidizing alloy based on iron metal, nickel metal and chromium metal.

### 1. Plant Tropism

It was qualitatively noted that certain plants are attracted by the surface of the glass panel: even after the stems somewhat moved away from the panel, it was observed that the stems bend and grow while turning back toward the glass surface where they become attached.

Unexpectedly, it is the panels which have a luminous transmittance (source D65, angle of observation 2°), under 4 mm-thick glass, of less than 64% which give rise to the stem tropism phenomenon. In this case, once the stems have attached to the glass panel, they no longer move away from said panel during their subsequent growth.

2. Number of Nodes with Secretion

For each stem and each type of glass support, the number of nodes that were in contact with the surface of the glass and that had secreted attachment resin, whether or not they were anchored to the surface of the glass panel, was detected and counted.

The means obtained for the panels consisting of the same type of glass gave the results reported in Table 1 which follows.

TABLE 1
nodes having given rise to secretion

| | | Total number of | | | | | | |
|---|---|---|---|---|---|---|---|---|
| | | Stems | Stems | | | | | |
| | | ob- | with | Anchor | | | | |
| | | served | anchoring | nodes | | | | |
| Op1 | 10.1 | 9 | 3 | 3 | 121 | 0.025 | 10.1 | 10.4 |
| Op2 | 8.6 | 9 | 1 | 1 | 106 | 0.009 | 4.6 | 2.4 |
| Op3 | 7.0 | 9 | 2 | 2 | 100 | 0.020 | 6.6 | 61.3 |
| Op4 | 6.4 | 9 | 1 | 1 | 134 | 0.007 | 7.6 | 1.1 |
| Op5 | 6.1 | 9 | 1 | 1 | 81 | 0.012 | 1.0 | 5.3 |
| Op6 | 4.8 | 9 | 1 | 1 | 114 | 0.009 | 5.1 | 76.6 |
| Ch1 | 10.4 | 9 | 1 | 1 | 130 | 0.008 | 3.2 | 1.6 |
| Ch2 | 4.4 | 9 | 1 | 1 | 117 | 0.009 | 6.7 | 8.7 |
| Ch3 | 3.6 | 9 | 1 | 1 | 119 | 0.008 | 7.9 | 41.5 |
| Ch4 | 3.5 | 4 | 1 | 1 | 142 | 0.007 | 178.9 | 8.6 |
| Ch5 | 2.8 | 9 | 1 | 1 | 66 | 0.015 | 14.7 | 7.8 |
| Ch6 | 2.7 | 6 | 2 | 2 | 114 | 0.018 | 35.1 | 9.3 |

The glasses used for the support panels were classified into 2 groups, namely:

a. “Optical” Group
Op1: glass with a steel gray appearance, coated with a hard coat comprising iron, chromium and cobalt oxides and tinted gray in its mass;
Op2: glass with a silvery gray appearance, with a hard coat comprising titanium oxide;
Op3: glass with a metallic green appearance, colored green in its mass and covered with the same hard coat as the Op1 glass;
Op4: glass with a clear metallic appearance, not colored in its mass and covered with the same hard coat as the Op1 glass;
Op5: glass with a gray appearance, colored in its mass, with no coat;
Op6: glass with a shiny silvery appearance, not colored in its mass and covered with the same hard coat as the Op2 glass.
   b. “Chemical” Group
Ch1: textured glass printed with a “galette” pattern, having a metallic appearance, not colored in its mass and covered with a coat of Fe—Ni—Cr stainless steel 30 nm thick;
Ch2: textured, non-colored glass with a steel gray appearance, printed with a pattern identical to the Ch1 glass and covered with a hard coat comprising TiO₂;
Ch3: uncoated clear glass;
Ch4: textured glass printed with a “galette” pattern, with no coat and having undergone a matting treatment by sandblasting;
Ch5: glass of which the surface has been modified by Cu⁺ ion diffusion;
Ch6: glass chemically textured by means of a hydrofluoric acid-based saline solution on one of its faces.

The luminous transmittance LT level of the panels used was also measured (source D65, angle of observation 2° under 4 mm-thick glass). The results are the following:

| Type of glass | % LT |
|---|---|
| Op1 | 20.7 |
| Op2 | 34.6 |
| Op3 | 31.9 |
| Op4 | 37.9 |
| Op5 | 49.1 |
| Op6 | 63.4 |
| Ch3 | 81.5 |
| Ch5 | 89.2 |

It is observed, in the FIGURE, that the number of nodes with secretion per stem is relatively well inversely correlated with the luminous transmittance level of the glass support panel: the higher this level is, the fewer nodes with secretion there are.

1. A green wall, comprising a solid support comprising a living climbing plant subject attached to a surface of the support,
wherein the plant subject is rooted in a soil immediately next to the wall, and the support comprises a glass object.

2. The green wall of claim 1, wherein the plant subject is at least one selected from the group consisting of a climbing plant of the Ficus genera, an ivy, and a virgin vine in the phylogenetic classification.

3. The green wall of claim 1, wherein the glass of the glass object is at least one selected from the group consisting of a textured glass and a glass comprising a coating comprising a metal or metal oxide.

4. The green wall of claim 1, wherein the glass object is a flat glass sheet having a luminous transmittance LT level of at most 65%, measured through a sheet thickness of 4 mm with a daylight source standardized as D65 by the CIE at a solid angle of observation of 2°.

5. The green wall of claim 1, wherein the glass object is a flat glass sheet inclined relative to the vertical direction by an angle which does not exceed 50 degrees of angle.

6. The green wall of claim 1, wherein the glass object comprises a coating comprising at least one metal oxide of a metal selected from the group consisting of an element of columns 4, 6, 8, 9, and 14 of the periodic table of elements.

7. The green wall of claim 6, wherein the metal oxide is an oxide of at least one metal selected from the group consisting of Fe, Ru, Os, Co, Rh, Ir, Cr, Mo, W, Ti, Zr, Hf, C, Si, Ge, Sn, and Pb.

8. The green wall of claim 6, wherein the metal oxide coating is a hard pyrolytic coat.

9. The green wall of claim 6, wherein the coating comprises a single coat of a metal, a metal alloy, or a metal oxide.

10. The green wall of claim 9, wherein the coating comprises an Fe, Co and Cr oxide.

11. The green wall of claim 8, wherein the coating comprises a Ti oxide.

12. The green wall of claim 6, wherein the coating comprises at least two coats of a metal oxide or at least two metallic coats.

13. The green wall of claim 12, wherein the coating comprises two superimposed coats, wherein the first coat is an undercoat comprising a Si oxycarbide and the second coat comprises a Sn oxide doped with fluorine or antimony.

14. A method for encouraging nodes of a climbing plant to anchor to a substantially vertical wall, the method comprising:
burying the roots of a plant in a soil immediately next to a base of a wall comprising a solid support comprising a glass object, wherein the glass object comprises a textured glass surface; and
contacting at least one selected from the group consisting of the roots and the leaves of the plant with water and nutritive elements, and a visible light sufficient to allow the growth of the plant via photosynthesis.

15. A method for encouraging nodes of a climbing plant to anchor to a substantially vertical wall, the method comprising:
burying the roots of a plant in a soil immediately next to a base of a wall comprising a solid support comprising a glass object, wherein the glass object comprises a glass surface coated with a metal or a metal oxide; and
contacting at least one selected from the group consisting of the roots and the leaves of the plant with water and nutritive elements, and sufficient light to allow the growth of the plant via photosynthesis.

16. The green wall of claim 6, wherein the coating comprises a single coat of a metal.

17. The green wall of claim 6, wherein the coating comprises a single coat of a metal alloy.

18. The green wall of claim 6, wherein the coating comprises a single coat of a metal oxide.

19. The green wall of claim 6, wherein the coating comprises at least two coats of a metal oxide.

20. The green wall of claim 6, wherein the coating comprises at least two metallic coats.
